(19) United States
(12) Patent Application Publication
(10) Pub. No.: US 2014/0279205 A1
(43) Pub. Date: Sep. 18, 2014

(54) DATE REMINDER SYSTEMS AND RELATED METHODS

(71) Applicant: United Parcel Service of America, Inc., Atlanta, GA (US)

(72) Inventors: Bala Ganesh, Alpharetta, GA (US); Scott Castaldo, Woodstock, GA (US); Amber Reed, Atlanta, GA (US)

(21) Appl. No.: 14/211,273

(22) Filed: Mar. 14, 2014

Related U.S. Application Data
(60) Provisional application No. 61/786,273, filed on Mar. 14, 2013.

(51) Int. Cl. G06Q 50/00; G06Q 30/06

(52) U.S. Cl. CPC G06Q 50/01; G06Q 30/0631
USPC 705/26.7

(57) ABSTRACT

A computer system for providing date reminders and gift recommendations is disclosed. The system receives event, purchase history, and social network data associated with a gift recipient (e.g., a first user). Based on the social network data, the system determines that the gift recipient is connected to a notification recipient (e.g., a second user) on a social network (e.g., the gift recipient and the notification recipient are “friends” on Facebook® or “connected” on) LinkedIN®. The system sends a notification to the notification recipient (e.g., via the social network) of a special event (e.g., a birthday) of the gift recipient based on the event data and also recommends gifts for the gift recipient based, at least in part, on the purchase history data.

### CLAIM OF PRIORITY

This application claims the benefit of priority under 35 U.S.C. §119(e) to the filing date of U.S. Provisional Patent Application No. 61/786,273 filed Mar. 14, 2013, entitled, “Date Reminder Systems and Related Methods,” which is incorporated herein by reference in its entirety.

### BACKGROUND

It is common for individuals to keep track of friends' and family members' important events (e.g., birthdays, anniversaries). However, in some cases, an individual may forget to document such events on their calendar. Even if a person remembers to document such an event, they may have trouble deciding on what type of gift to purchase to celebrate the event. Various embodiments of the present systems and methods address this issue.

### SUMMARY

According to various embodiments, a computer system for recommending gifts for special events includes at least one processor and is configured for: 1) receiving event data associated with a gift recipient, wherein the event data includes a date of at least one special event; 2) receiving purchase history data associated with the gift recipient, wherein the purchase history data includes purchase data associated with at least one purchase made by the gift recipient; 3) receiving social network data indicating that the gift recipient and the notification recipient are connected on a social network; 4) determining that the date of the at least one special event occurs in the near future; 5) determining, based at least in part on the purchase history data, at least one item that would be suitable as a gift for the gift recipient for the at least one special event; and 6) at least partially in response to determining that the date of the at least one special event occurs in the near future, conveying a date reminder notification to the notification recipient, wherein the notification includes: i) the date of the at least one special event; and ii) information associated with the at least one item that would be suitable as the gift for the gift recipient for the at least one special event.

In a particular embodiment, a non-transitory computer-readable medium stores computer readable instructions for: 1) receiving one or more date reminder notifications for a notification recipient, wherein the one or more date reminder notifications include: i) the date of at least one special event associated with a gift recipient, wherein the notification recipient and gift recipient are associated on a social network; and ii) information associated with at least one item that would be suitable as a gift for the gift recipient for the at least one special event; 2) displaying the one or more date reminder notifications to the notification recipient; 3) enabling the notification recipient to purchase the at least one item that would be suitable as the gift for the gift recipient for the at least one special event, wherein the at least one item is determined to be suitable as the gift for the gift recipient for the at least one special event by a remote computing system based at least in part on social network data associated with the gift recipient.

In one or more embodiments, a computer system for recommending gifts for special events includes at least one processor, and is configured for: 1) receiving event data associated with a gift recipient, wherein the event data includes a date of at least one special event; 2) receiving wish-list data associated with the gift recipient, wherein the wish-list data includes data associated with at least one item indicated by the gift recipient to be included in a wish-list; 3) receiving social network data indicating that the gift recipient and a notification recipient are connected on a social network; 4) determining that the date of the at least one special event occurs in the near future; 5) at least partially in response to determining that the date of the at least one special event occurs in the near future, conveying a date reminder notification to the notification recipient, wherein the notification includes the date of the at least one special event; and 6) enabling the notification recipient to contribute payment to the at least one item included in the wish-list associated with the gift recipient.

### BRIEF DESCRIPTION OF THE DRAWINGS

Reference will now be made to the accompanying drawings, which are not necessarily drawn to scale, and wherein:

FIG. 1 is a block diagram of a Date Reminder System according to one embodiment;

FIG. 2 is a block diagram of an Exemplary Logistics Server of FIG. 1;

FIG. 3 shows a flow diagram that generally illustrates various steps executed by the exemplary Data Analysis and Gift Recommendation Module in FIG. 2 in accordance with various embodiments of the system of FIG. 1;

FIGS. 4A-4H depict screenshots and descriptions of various aspects and embodiments of the exemplary Data Analysis and Gift Recommendation Module of FIG. 2.

### DETAILED DESCRIPTION OF VARIOUS EMBODIMENTS

Various embodiments will be described more fully hereinafter with reference to the accompanying drawings. It should be understood that the invention may be embodied in many different forms and should not be construed as limited to the embodiments set forth herein. Like numbers refer to like elements throughout.

### System Overview

Computer systems, according to various embodiments, provide users with one or more enhanced date reminders. The reminders may provide a particular user with a notification (e.g., the notification recipient) of another person's (e.g., a gift recipients', a friend's, family member's, and/or a colleague's) one or more life events, such as, for example, a birthday or anniversary. In various embodiments, when providing the one or more date reminders to the notification recipient, the system may be configured to recommend one or more gifts that would be appropriate for the gift recipient. The system, in particular embodiments, may be configured to determine one or more appropriate gift suggestions based at least in part on data associated with the gift recipient, which may, for example, be social network data, event data, purchase history data, etc. associated with the gift recipient.

In various embodiments, the system may be configured to receive and analyze the gift recipient's data relating to one or more previous purchases, events, and/or the gift recipient's social network preferences to determine one or more appropriate gifts. The purchasing data may include information about the gift recipient's previous online purchases, including one or more product descriptions, price paid, and shipping methods. The social network data may indicate the gift recipient's one or more likes, dislikes, geographic locations, income levels, employment statuses, connections, and/or one or more events as indicated on the social network. The gift recipient's event data, which may be included in the social network data, may include the gift recipient's birthday, anniversary, graduations, wedding date, or any other event which may be desirous for the notification recipient to know about. Based at least in part on this data, according to particular embodiments, the system may be configured to determine which one or more events are important to the gift recipient, what type of purchases they may themselves make, and which other users (e.g., the notification recipient) of the system they may know.

In a particular example, the system is configured to receive data about the gift recipient and the notification recipient. This data may include the gift recipient and the notification recipient's purchasing, social network, and event data. In this example, the gift recipient's thirty-fifth birthday is on March 19. The system has determined, through the received data, that the gift recipient and the notification recipient know each other. The system has also determined one or more appropriate gifts for the gift recipient based on the gift recipient's purchasing habits and one or more indicated likes on a social network. On March 12, the system is configured to send a notification to the notification recipient, informing him of the gift recipient's upcoming birthday and, based on the data associated with the gift recipient, suggest one or more gift ideas.

The system indicated above may be implemented in one or more ways by one or more entities. In some embodiments, the system is provided by a logistics company or any other suitable company that can access consumer data. In particular embodiments, the system includes a user's computing device (laptop computer, desktop computer, mobile device, etc.), on a company's one or more servers, one or more social network servers, one or more third party servers (e.g., a retailer's server), or any combination of user's devices and the company's servers.

### Exemplary Technical Platforms

As will be appreciated by one skilled in the relevant field, the present invention may be, for example, embodied as a computer system, a method, or a computer program product. Accordingly, various embodiments may be entirely hardware, entirely software, or a combination of hardware and software. Furthermore, particular embodiments may take the form of a computer program product stored on a computer-readable storage medium having computer-readable instructions (e.g., software) embodied in the storage medium. Various embodiments may also take the form of web-implemented computer software. Any suitable computer-readable storage medium may be utilized, including, for example, hard disks, compact disks, DVDs, optical storage devices, and/or magnetic storage devices.

Various embodiments are described below with reference to block diagrams and flowchart illustrations of methods, apparatus (e.g., systems), and computer program products. It should be understood that each element of the block diagrams and flowchart illustrations, and combinations of elements in the block diagrams and flowchart illustrations, respectively, can be implemented by a computer executing computer program instructions. These computer program instructions may be loaded onto a general purpose computer, a special purpose computer, smart mobile device, or other programmable data processing apparatus to produce a machine. As such, the instructions which execute on the general purpose computer, special purpose computer, smart mobile device, or other programmable data processing apparatus create means for implementing the functions specified in the flowchart block or blocks. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

These computer program instructions may also be stored in a computer-readable memory that can direct a computer or other programmable data processing apparatus to function in a particular manner such that the instructions stored in the computer-readable memory produce an article of manufacture that is configured for implementing the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Accordingly, block diagram elements and flowchart illustrations support combinations of mechanisms for performing the specified functions, combinations of steps for performing the specified functions, and program instructions for performing the specified functions. It should also be understood that each block diagram element and flowchart illustration, and combinations of block diagram elements and flowchart illustrations, can be implemented by special purpose hardware-based computer systems that perform the specified functions or steps, or combinations of special purpose hardware and other hardware executing appropriate computer instructions.

### Exemplary System Architecture

FIG. 1 shows a block diagram of a Date Reminder System 10 according to a particular embodiment. As may be understood from this figure, the Date Reminder System 10 may include one or more Computer Networks 15, a Logistics Server 25, one or more Third Party Servers 35 (e.g., a web hosting server, retailer's server, any other server that hosts websites), a Social Network Server 45 (e.g., a server associated with a social network) and one or more of the following: (1) a Mobile Computing Device 12 (e.g., a handheld computing device, a laptop computer, a tablet computer, or any other mobile computing device); and a Desktop Computer 14.

The one or more Networks 15 facilitate communication between the Mobile Computing Device 12, Desktop Computer 14, Logistics Server 25, Third Party Servers 35, and Social Network Server 45. These one or more Networks 15 may include any of a variety of types of computer networks such as the Internet, a private intranet, a public switch telephone network (PSTN), WAN, LAN, or any other type of suitable network. In certain variations of the embodiment shown in FIG. 1, the communication link between the Mobile Computing Device 12, the Desktop Computer 14, the Logistics Server 25, the one or more Third Party Servers 35, and/or the Social Network Server 45 may be implemented via the Internet using Internet Protocol (IP).

It should be understood that the Servers 25, 35, and 45 do not necessarily need to be deployed over the network. For example, in various embodiments, any or all of Severs 25, 35, and 45 may be deployed locally on the user's computer, tablet, and/or mobile device.

FIG. 2 shows a block diagram of an exemplary embodiment of an exemplary Logistics Server 25 that is configured for executing a Webpage Detection, Data Collection, Purchase Tracking, and Display Module 300. It should be understood based on this disclosure that any suitable computers (e.g., any of the computing devices shown in FIG. 1) may be used to execute this module and that various steps executed by the module may be executed on different computers.

The Logistics Server 25 may include one or more basic computer hardware components. As may be understood from FIG. 2, in this embodiment, the Logistics Server 25 includes a Processor 60 that communicates with other elements within the Logistics Server 25 via a System Interface or Bus 61. The Logistics Server 25 also includes a Display Device/Input Device 64 for receiving and displaying data. This Display Device/Input Device 64 may be, for example, a keyboard, voice recognition, or pointing device that is used in combination with a monitor. The Logistics Server 25 further includes a Memory 66, which preferably includes both a Read Only Memory (ROM) 65 and a Random Access Memory (RAM) 67. The server's ROM 65 may be used to store a Basic Input/Output System (BIOS) 26 that contains the basic routines that help to transfer information between elements within the Logistics Server 25.

Also located within the Logistics Server 25 is a Network Interface 74 for interfacing and communicating with other elements of a computer network. It will be appreciated by one of ordinary skill in the art that one or more components of the Logistics Server 25 may be located geographically remote from other components of the Logistics Server 25 and/or that certain components may be omitted from particular embodiments. Furthermore, one or more of the components may be combined, and additional components performing functions described herein may be included in the Logistics Server 25.

The Logistics Server 25 may also include at least one Storage Device 63, such as a hard disk drive, a floppy disk drive, a CD-ROM drive, or an optical disk drive, for storing information on various computer-readable media, such as a hard disk, a removable magnetic disk, or a CD-ROM disk. As will be appreciated by one of ordinary skill in the art, each of these Storage Devices 63 may be connected to the Bus 61 by an appropriate interface. The Storage Devices 63 and their associated computer-readable media may provide nonvolatile storage for the Logistics Server 25. It should be noted that the computer-readable media described above could be replaced by any other type of computer-readable media known in the art. Such media includes, for example, magnetic cassettes, flash memory cards, and digital video disks.

A number of program modules may be stored by the various storage devices and/or within the RAM 67. Such program modules include an Operating System 80 and a Webpage Detection, Data Collection, Purchase Tracking, and Display Module 300. For simplicity and brevity, these modules are merely exemplary and may represent a number of program modules which control certain aspects of the operation of the Logistics Server 25 with the assistance of the Processor 60 and the Operating System 80. Exemplary embodiments of the Webpage Detection, Data Collection, Purchase Tracking, and Display Module 300 are described in more detail below.

### Exemplary Data Analysis and Gift Recommendation Module

As shown in FIG. 3, certain embodiments of the Data Analysis and Gift Recommendation Module 300 are configured to gather user data for providing one or more event reminders and recommending one or more gifts tailored to a particular user. The Data Analysis and Gift Recommendation Module 300 may operate alone or in combination with the Operating System 80 to perform the functions show in FIG. 3. It should be understood by one skilled in the art that certain embodiments of a Data Analysis and Gift Recommendation Module 300 may perform the functions shown in FIG. 3 in an order other than the order shown in FIG. 3. It should also be understood that various systems, when executing a Data Analysis and Gift Recommendation Module 300 may omit one or more particular functions or perform one or more additional functions in performing the functions of the Data Analysis and Gift Recommendation Module 300.

### Exemplary Embodiment of the Data Analysis and Gift Recommendation Module Shown in FIG. 3

### The System Receives Data and Information

Beginning with Step 302, the system receives data associated with a gift recipient. In various embodiments, the received data includes: 1) social network data associated with at least a notification recipient that is connected to the gift recipient by an online social network; 2) purchase history data regarding at least one purchase that the gift recipient has made in the past; and 3) event data that includes a date of at least one special event associated with the gift recipient.

The social network data may include one or more types of data and the system may be configured to receive the social network data from any online network where users connect and submit data, public or private, including Facebook®, LinkedIN®, and MyChoice®. In various embodiments, the social network data includes certain information associated with the gift recipient, including the gift recipient's one or more likes (including products and/or companies) and dislikes, age, gender, religious beliefs, political views, one or more quotations, contact information, relationship status, one or more places the user has lived, where the user currently lives, where the user attended school, the user's profession, where the user has worked, where the user currently works, etc. In some embodiments, the social network data includes the gift recipient's current home address. In many embodiments, the social network data includes the gift recipient's one or more connections on the social network (e.g., “friends” on Facebook®) and the names of one or more other users that are associated with the gift recipient in the context of the social network. In particular embodiments, the social network data includes event data associated with one or more important events of the gift recipient as indicated on the social network.

In various embodiments, the event data may include, for example, data regarding the gift recipient's birthday, anniversary, graduation, or any other event associated with the gift recipient. The event data may be received from one or more sources associated with the gift recipient, including, but not limited to: 1) a calendar; 2) the social network (e.g., birthday reminders); 3) Outlook®; and/or 4) any other suitable source associated with the gift recipient. In some embodiments, the event data includes: the date of the event; what that date represents to the gift recipient (e.g., a birthday), etc. For example, if the event data is received from the social network, the event data may include the gift recipient's birthday as well as the gift recipient's age and one or more gifts the user has received for their birthday in the past.

The purchase history data may include information from any online retailer regarding one or more purchases associated with the gift recipient. In various embodiments, the purchase history data includes: 1) the date of one or more purchases made by the gift recipient; 2) the one or more items purchased by the gift recipient from an online retailer; and 3) the method of shipping used to deliver one or more parcels from an online retailer to the gift recipient. The system, in particular embodiments, is configured to receive the purchasing data from any suitable source, which may include, for example: 1) one or more online retailer servers (e.g. the one or more Third Party Servers 35); 2) an online social network with an account associated with the gift recipient (e.g., the Social Network Server 45); and/or 3) a browser or email plug-in installed on a computing device of the gift recipient which is confirmed to collect purchase history data about the gift recipient.

### The System Sends a Date Reminder Notification

Returning to Step 304, the system continues by determining that the date of least one special event associated with the gift recipient occurs in the near future. In various embodiments, the “near future” may be a predetermined amount time. In particular embodiments, the predetermined amount of time varies depending on the event (e.g., the “near future” may be one week for a birthday and two weeks for an anniversary). According to a various embodiments, the predetermined amount of time is determined by the system based on any appropriate factors, such as the importance of the event as indicated by the gift recipient, etc. According to other embodiments, the system enables the notification recipient to select the predetermined amount of time to be reminded of the gift recipient's one or more special events.

At Step 306, the system, at least partially in response to determining that the date of the at least one special event occurs in the near future, conveys a first date reminder notification to the notification recipient. In various embodiments, the first date reminder notification includes the date of the at least one special event of the gift recipient. According to particular embodiments, the system is configured to determine, based on the event data and the social network data associated with the gift recipient and the notification recipient that the notification recipient wishes to receive notification of the gift recipient's special event.

According to other embodiments, the system may be configured to enable the notification recipient to select which reminders to receive for the gift recipient's one or more special events. The system may be configured to enable the notification recipient to select which reminders to receive for the gift recipient's one or more special events in any suitable way. In a particular embodiment, the system is configured to enable the notification recipient to select which reminders to receive for the gift recipient's one or more special events on a social network associated with the notification recipient. In this embodiment, for example, the system is configured to enable the notification recipient to select one or more events associated with the gift recipient from a list of special events displayed on the social network (e.g., the gift recipient's birthday, the gift recipient's graduations, and/or the gift recipient's anniversary). The notification recipient may select the one or more special events associated with the gift recipient in any suitable way, including: 1) selecting a check-box on the social network associated with the gift recipient's particular special event; 2) selecting a gift recipient's one or more special events from a list of one or more special events provided by the system; and 3) selecting a gift recipient's one or more special events from any other website and/or electronic communication from the system.

The system may be configured to convey the first date reminder in any suitable way. In various embodiments, the system is configured to convey the first date reminder to the notification recipient via a message on the social network associated with the notification recipient. In other embodiments, the system is configured to convey the first date reminder notification in one or more other suitable electronic ways, such as: by email; by SMS message; and/or by another web notification. As a particular example, the system determines (e.g., from the social network data) that the gift recipient and the notification recipient are connected (e.g., friends) on the social network. The system also determines, from the social network, that the gift recipient's birthday is in ten days. In this example, the system conveys first date reminder notification to the notification recipient, notifying the notification recipient of the gift recipient's birthday in ten days via a message on the social network.

In particular embodiments, the system is configured to enable the notification recipient to take one or more actions regarding the special event of the gift recipient. According to various embodiments, the system is configured to include with the first and/or second date reminder (the second date reminders described below), a mechanism for enabling the notification recipient to print a shipping label including the gift recipient's shipping address from the first and/or second date reminder. In various embodiments, the system is configured display a user-selectable indicium with the first and/or second date reminder. The system may be configured to enable the notification recipient to print a shipping label by selecting the user-selectable indicium included with the first and/or second date reminder.

At least partially in response to the notification recipient selecting the indicium, in various embodiments, the system is configured to substantially automatically (e.g., automatically) send a shipping label including the gift recipient's default address (e.g., the address the gift recipient has listed on the social network or associated with the system) to the notification recipient's default printer (e.g., the printer connected to the notification recipient's client device). In other embodiments, at least partially in response to the notification recipient selecting the indicium, the system is configured to link the notification recipient to an external website where a shipping label can be manually created and then printed. In further embodiments, the system, when the notification recipient selects the indicium, is configured to send a shipping label to the notification recipient in a message such as an email, a SMS message, or a message on a social network. In particular embodiments, the shipping label includes the address of the gift recipient, the notification recipient's preferred shipping service (e.g., “UPS Ground”), the notification recipient's return address, and/or any special shipping instructions for the gift recipient (e.g., “Drop-off behind gate”).

In still other embodiments, the system is configured to enable the notification recipient to view a wish-list of the gift recipient with the notification. In various embodiments, the wish-list is displayed in the body of the notification. In other embodiments, the wish-list is viewable to the notification recipient by selecting a user-selectable indicium. The indicium may be selected in any of the ways (or other ways than) discussed above. In further embodiments, the system is configured to invite the notification recipient to view the gift recipient's wish-list on a separate website. In still further embodiments, the system is configured to send the notification recipient the gift recipient's wish-list by message, such as an email, SMS message, and/or social network message.

In various embodiments, the wish-list is a list of one or more items the gift recipient has indicated they wish to purchase or wish to receive as gifts. In particular embodiments, the wish-list is a wish-list from a website or online retailer (e.g., an Amazon® wish-list). In other embodiments, the wish-list is a wish-list populated by the gift recipient on the social network. In further embodiments, the wish-list is populated by a logistics server (e.g., the Logistics Server 25) and associated with a user account (e.g., on UPS MyChoice®). The wish-list may be specific to the special event included in the notification or the wish-list may be a general wish-list (e.g., items the gift recipient wants as gifts or to purchase for any event).

In further embodiments, the system is configured to include, with the notification, a mechanism for enabling the notification recipient to create a message for the gift recipient (e.g., to send to the gift recipient for the special event). The mechanism may be, for example, a user-selectable indicium, which may be selected in any of the ways (or other ways than) discussed above.

In various embodiments, the system is configured to enable the notification recipient to create the message for the gift recipient and send it to the gift recipient through the social network. In other embodiments, the system is configured to enable the notification recipient to create the message for the gift recipient and send it to the gift recipient through any other way, such as email, SMS message, and/or instant message.

The system may be configured to send the message to the gift recipient immediately after the notification recipient creates the message. In a particular example, the notification recipient receives a notification that the gift recipient's birthday is in a predetermined number of days (e.g., three days). The notification recipient then selects an indicium and is prompted to create a message for the gift recipient. The notification recipient creates the message for the gift recipient, indicates they wish to send the message (e.g., by selecting a “send” button), and the message is sent to the gift recipient substantially immediately (e.g., immediately).

In other embodiments, the system sends the message on the date of the gift recipient's special event. In various embodiments, after the notification recipient creates the message, the system stores the message (or facilitates storage of the message) until the date of the gift recipient's special event and then sends the message to the gift recipient. The message may be a video message, a photo message, an audio message, a SMS message, or any other type of electronic message.

### The System Determines a Suitable Gift for the Gift Recipient and Notifies the Notification Recipient of the Suitable Gift

Continuing to Step 308, the system determines, based at least in part on the purchase history data associated with the gift recipient, at least one item that would be suitable as a gift for the least one special event. In various embodiments, the system is configured to determine one or more suitable gifts for the gift recipient and the special event in any suitable manner. According to particular embodiments, the system is configured to identify one or more previous purchases made by the gift recipient based on the gift recipient's purchase history data. In this embodiment, the system then determines one or more gifts that are similar, in the same price range, and/or an accessory of the one or more items in the gift recipient's purchase history. In some embodiments, the system also takes into account a “wish-list” of one or more gift ideas provided by the gift recipient to suggest a gift or gifts for the notification recipient to purchase for the gift recipient. According to a particular embodiment, the system may take into account one or more items that the gift recipient has previously viewed, one or more items related to items the gift recipient has previously viewed, one or more items that individuals who viewed the same items as the gift recipient also viewed, and/or one or more items that individuals who purchased the same items as the gift recipient also purchased.

In other embodiments, the system determines a suitable gift based on a combination of the purchase history and social network data associated with the gift recipient. In some embodiments, the system identifies one or more previous purchases of the gift recipient based on the purchase history data then further narrows the one or more possible gifts ideas to suggest to the notification recipient based on the gift recipient's social network data. According to one embodiment, the system uses the gift recipient's indicated one or more likes and dislikes on the social network to further narrow the one or more possible suitable gifts. According to another embodiment, the system uses other information, such as age, gender, and employment status to further determine one or more suitable gifts for the gift recipient.

In particular embodiments, the system is configured to use a maximum price provided by the notification recipient or the gift recipient to determine a suitable gift. In various embodiments, the system may be configured to enable the notification recipient to set a maximum price that they would like to spend on gifts for special events for other users (e.g., the gift recipient). The system may then be configured to consider the maximum price when recommending a suitable gift. As a particular example, if a gift recipient has indicated an interest in computers on a social networking site, the system would not likely recommend that the notification recipient purchase a new laptop computer as a gift for the gift recipient if the notification recipient has indicated a desire to limit gift spending to ten dollars per gift.

Returning to Step 310, after determining that the at least one item would be suitable as a gift for the at least one special event, the system notifies the notification recipient of the suitable gift recommendation indicating that the at least one item would be suitable as a gift for the at least one special event. In particular embodiments, the system is configured to notify the notification recipient of the gift recommendation and additionally enable the notification recipient to do any of the other actions discussed in Step 306 (e.g., print a shipping label, create a message, and/or view a gift recipient wish-list). In various embodiments, the system notifies the notification recipient of the gift recommendation and the special event in the same notification. In particular embodiments, the system notifies the notification recipient by message, email, SMS message, and/or other web notification.

In various embodiments, the system is configured to enable the notification recipient to purchase the item(s) that would be suitable as a gift for the at least one special event of the gift recipient. The system may be configured to enable the notification recipient to purchase the at least one item (or other items) in any suitable way. According to a particular embodiment, the system may enable the notification recipient to purchase the at least one item by selecting (e.g., clicking) on a user-selectable indicium (e.g., a link), which, for example, may open a webpage for completing the purchase on which the notification recipient may complete the purchase of the at least one item. In other embodiments, the notification recipient may complete the purchase of the at least one item by selecting (e.g., clicking) on a user-selectable indicium to complete the purchase, wherein the user-selectable indicium is part of a computer system that stores account information for the notification recipient (e.g., payment information, billing address, etc. associated with the notification recipient).

At least partially in response to the notification recipient purchasing the at least one item, in various embodiments, the system is further configured to facilitate shipping the at least one item to the gift recipient. The system may be configured to facilitate shipping of the at least one item in one or more suitable ways. In a particular embodiment, the system is associated with a logistics company and the logistics company: 1) receives notification of the purchase of the at least one item by the notification recipient; and 2) facilitates transportation of one or more parcels containing the at least one item to the gift recipient.

### Exemplary User Experience

FIGS. 4A-4D depict screenshots of exemplary embodiments of the System 10. FIG. 4A shows the system associated with Facebook® and how a user can invite friends to accept being chosen as one of those who will receive a text message event reminder of their one or more special events. As shown on the left, the system allows a user to select friends for inclusion in the date reminder system by checking a box next to one or more friends' names and pictures. The one or more selected friends will receive notifications of the user's one or more special events. The system may also be configured to enable a user to be provided with a wish-list associated with a friend that the user has selected.

Depicted on the right of FIG. 4A is an example of how the system may post (e.g., to a user's social network profile) an invitation to a friend to join the date reminder system. Here, the system indicates that a friend has been selected as a “close friend.” This selected close friend will receive a text message (e.g., an SMS message) regarding this friend's birthday.

FIGS. 4B-4D show an exemplary date reminders tab integrated into Facebook®. Here, the tab functionality is integrated with the social network through an application. In FIG. 4B, on the left, the tab shows friends' events visually depicted on a calendar. As shown, the calendar displays dates with each friend's picture (from their social network profile) displayed in the date of their special event.

FIG. 4C shows pop-ups (e.g., reminders or notifications) that are “pushed” to the user. The push notification shows the friend's profile picture, name, and the basic information about their event. Additionally, the push notification may show suggested gift ideas and/or other actions the user may take as described above.

FIG. 4D shows a different view of a user's friends' upcoming events. Instead of a “calendar view” as in FIGS. 4B and 4C, this embodiment shows the date reminders in a ‘list view.” This view may allow users to view other user's upcoming events beyond what is shown in the calendar view in FIG. 4B.

### Exemplary Alternative Embodiments

Alternative embodiments of the system may comprise features that are, in some respects, similar to the various components described above. Selected distinguishing features of these alternative embodiments are discussed below.

### A Notification Sent to the Notification Recipient May Include a Wish-List of the Gift Recipient

FIGS. 4E-4H depict screenshots of exemplary alternate embodiments of the System 10, wherein the notification recipient may make contributions (e.g., partial payments) toward the total price of the at least one item that the system has determined would be a suitable gift for the at least one special event of the gift recipient (e.g., at Step 308). FIG. 4E depicts a user interface displaying a wish-list (e.g., “Lisa's wishlist”), associated with a gift recipient (e.g., “Lisa”). The wish-list contains two items (e.g., “Jcp™ Modern Wool Peacoat” and “iPad mini with Wi-Fi 16G—White & Silver”), which, in a particular embodiment, the system may have determined as items that would be suitable as a gift for the least one special event of the gift recipient (e.g., as described in Step 308).

Continuing with FIG. 4E, the system is configured to provide two purchasing options for the notification recipient (e.g., at Step 310): 1) “Buy Gift;” and 2) “Contribute.” Additionally, the system is configured, in this example, to provide (e.g., display) information regarding the total price of the item, how much has been contributed by other friends (e.g., one or more other notification recipients), and how much money needs to be contributed to purchase the item (e.g., how much of the total is left to be contributed).

In various embodiments, the “Buy Gift” option enables the notification recipient to pay the remainder of the purchase price to purchase the item for the gift recipient (e.g., the total cost of the item less the total amounts contributed by the one or more other notification recipients, if any). According to a particular embodiment, the “Contribute” button enables the notification recipient to contribute less than the total amount remaining to purchase the item. In a particular example, the notification recipient selects the “Contribute” button and enters $20 in a field to contribute $20 to the gift for the gift recipient. In this example, the total price of the gift is $100 and the total contributed by one or more other notification recipients is $70. Therefore, in the present example, to complete the purchase, the gift recipient needs $10 more to be contributed (e.g., $100 total less the $70 contributed by the one or more other notification recipients and less the $20 contributed from the notification recipient, is $10).

In various embodiments, the user interface displays (e.g., on the right) upcoming dates for other users so the user using the interface (e.g., “Lisa” or the gift recipient) can purchase or contribute to gifts for other users.

Turning to FIG. 4F, the system is configured to display a pop-up style window in response to the user selecting the “Buy gift” button. In this example, the system is configured to display the remaining price left to buy the gift for the gift recipient (e.g., $20). The system, in this example, is also configured to display a user-selectable indicium (e.g., “Buy”) that, when selected, completes the transaction for the notification recipient. In this example, the notification recipient has an account associated with a service (e.g., UPS MyChoice®) that contains account information for the notification recipient, which enables the notification recipient to complete the purchase transaction by selecting “Buy” and being charged on their credit card or by being charged in another suitable way.

FIG. 4G depicts an embodiment of the system in which the system is configured to display a pop-up notification to the notification recipient in response to the notification recipient purchasing (or contributing to) the gift for the gift recipient. In this example, the pop-up notification also displays a user-selectable indicium which, in some embodiments, posts a message on a social network (e.g., Facebook®) regarding the purchase.

Continuing with FIG. 4H, the system is configured, in various embodiments, to send a notification to the gift recipient in response to the one or more notification recipients purchasing a gift for the gift recipient. The notification, according to particular embodiments, shows which friends contributed to the gift and which gift the friends purchased. In a particular embodiment, the system is also configured to include in the notification a user-selectable indicium that enables the user to post on a social network regarding the gift. In other embodiments, the system is configured to enable the user to send a thank you video to the one or more notification recipients who contributed to purchasing the gift for the gift recipient. The notification may be sent to the gift recipient in any suitable way, including via email, via social network message, and/or via SMS message.

The System May Estimate the Relationship between the Notification Recipient and the Gift Recipient

According to certain embodiments, using a combination of the social network data, the purchase history data, and the event data, the system may be configured to determine or estimate the type of relationship between the gift recipient and the notification recipient. In various embodiments, the system is configured to determine a connection between the gift recipient and the notification recipient based on more than, for example, a formal association between the gift recipient and the notification recipient on a social network. In various embodiments, the system is configured to collect data such as the gift recipient and the notification recipient's respective one or more geographic locations and/or the gift recipient and the notification recipient's respective one or more affiliations to schools, companies, or other networks.

In a particular example, the system may determine that two individuals who are connected on a social network are both students at a local university. In this example, the system uses social network and geography data collected from the social network associated with both individuals that indicates that the two individuals live close to each other in what is typically student housing and both individuals have indicated that they like the same university on the social network.

In particular embodiments, the system is further configured to determine whether the relationship between the gift recipient and the notification recipient is such that the notification recipient would desire to be reminded of particular events relating to the gift recipient (e.g., a user may be interested in being reminded of their cousin's birthday, but may not be interested in a wedding anniversary for a friend that they attended high school with).

### The System May Be Configured to Enable the Gift Recipient to Select One or More Notification Recipients

In various embodiments, the system may be configured to enable the gift recipient to select which one or more users (e.g., the notification recipient) they wish the system to send a notification to regarding the gift recipient's one or more special events (e.g., which users the gift recipient wishes to receive a first date reminder notification about her upcoming birthday). The system may be configured to enable the gift recipient to select one or more users they wish the system to send a notification regarding their special event in any suitable way. According to a particular embodiment, the system is configured to enable the gift recipient to select one or more users they wish the system to send a notification regarding their special event on a social network associated with the gift recipient. In one embodiment, the system is configured to enable the gift recipient to select one or more users to receive a notification by selecting a check-box next to a picture representing one or more users (e.g., the notification recipient) on the social network associated with the gift recipient, indicating that the gift recipient wishes the one or more selected users to receive a notification regarding their one or more special events.

### CONCLUSION

Many modifications and other embodiments of the present systems and methods will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for the purposes of limitation.

We claim:

1. A computer system for recommending gifts for special events, the system comprising:
at least one processor, wherein the computer system is configured for:
(A) receiving event data associated with a gift recipient, wherein the event data comprises a date of at least one special event;
(B) receiving purchase history data associated with the gift recipient, wherein the purchase history data comprises purchase data associated with at least one purchase made by the gift recipient;
(C) receiving social network data indicating that the gift recipient and the notification recipient are connected on a social network;
(D) determining that the date of the at least one special event occurs in the near future;
(E) determining, based at least in part on the purchase history data, at least one item that would be suitable as a gift for the gift recipient for the at least one special event; and
(F) at least partially in response to determining that the date of the at least one special event occurs in the near future, conveying a date reminder notification to the notification recipient, wherein the notification comprises:
i) the date of the at least one special event; and
ii) information associated with the at least one item that would be suitable as the gift for the gift recipient for the at least one special event.

2. The computer system of claim 1, wherein the computer system is further configured for receiving gift recipient social network data associated with the gift recipient, wherein the gift recipient social network data comprises information associated with at least one interest indicated by the gift recipient on the social network.

3. The computer system of claim 2, wherein determining at least one item that would be suitable as a gift for the gift recipient for the at least one special event is further based, at least partially on, the gift recipient social network data.

4. The computers system of claim 3, wherein the information associated with the at least one interest indicated by the gift recipient on the social network comprises information associated with an indication associated with an interest of the gift recipient selected from the group consisting of:
(A) a particular type of music;
(B) one or more products; and
(C) one or more television shows.

5. The computer system of claim 1, wherein the date of the at least one special event is a date selected from the group consisting of:
(A) a date of a birthday associated with the gift recipient;
(B) an anniversary date associated with the gift recipient; and
(C) a graduation date associated with the gift recipient.

6. The computer system of claim 1, wherein the computer system is further configured for enabling the notification recipient to purchase the at least one item that would be suitable as the gift for the gift recipient.

7. The computer system of claim 6, wherein the computer system is further configured for facilitating sending the purchased at least one item to the gift recipient.

8. The computer system of claim 1, wherein receiving the event data comprises receiving the event data from a computing device, wherein the gift recipient manually enters the event data into the computing device.

9. The computer system of claim 8, wherein the event data comprises a date of a birthday associated with the gift recipient.

10. The computer system of claim 1, wherein the computer system is further configured to send a wish-list of the gift recipient to the notification recipient.

11. The computer system of claim 10, wherein the first date reminder notification further comprises the wish-list of the gift recipient.

13. The computer system of claim 10, wherein the computer system is further configured for enabling the notification recipient to initiate an Internet search associated with the wish-list of the gift recipient.

14. A computer system for recommending one or more gifts for one or more special occasions, the system comprising:
at least one processor, wherein the computer system is configured for:
(A) receiving event data associated with a gift recipient, wherein the event data comprises a date of at least one special event;
(B) receiving purchase history data associated with the gift recipient, wherein the purchase history data comprises purchase data associated with at least one purchase made by the gift recipient;
(C) receiving gift recipient social network data associated with the gift recipient, wherein the gift recipient social network data comprises:
i) information associated with at least one interest indicated by the gift recipient on the social network; and
ii) an indication that the gift recipient and the notification recipient are connected on the social network;
(D) determining that the date of the at least one special event occurs in the near future;
(E) determining at least one item that would be suitable as a gift for the gift recipient for the at least one special event, based at least in part on:
i) the purchase history data; and
ii) the gift recipient social network data; and
(F) at least partially in response to determining that the date of the at least one special event occurs in the near future, conveying a date reminder notification to the notification recipient, wherein the date reminder notification comprises:
i) the date of the at least one special event of the gift recipient; and
ii) means of purchasing the at least one item that would be suitable as the gift for the gift recipient for the at least one special event.

15. The computer system of claim 14, wherein the gift recipient social network data further comprises the event data.

16. The computer system of claim 15, wherein the date reminder notification is conveyed to the notification recipient via the social network.

17. The computer system of claim 16, wherein the date reminder notification is conveyed to the notification recipient via a message on the social network.

18. The computer system of claim 16, wherein the date reminder notification is conveyed to the notification recipient via a posting on a message board on the social network

19. The computers system of claim 14, wherein the system is configured to receive the event data from a source selected from the group consisting of:
(A) a calendar program associated with the gift recipient;
(B) an email program associated with the gift recipient; and
(C) manual entry of the event data by the notification recipient.

20. The computer system of claim 14, wherein the computer system is further configured to enable the notification recipient to print a shipping label, wherein the shipping label comprises the shipping address of the gift recipient.

21. The computer system of claim 20, wherein the computer system is further configured to enable the notification recipient to print the shipping label from the date reminder notification.

22. A non-transitory computer-readable medium storing computer readable instructions for:
(A) receiving one or more date reminder notifications for a notification recipient, wherein the one or more date reminder notifications comprise:
i) the date of at least one special event associated with a gift recipient, wherein the notification recipient and gift recipient are associated on a social network; and
ii) information associated with at least one item that would be suitable as a gift for the gift recipient for the at least one special event;
(B) displaying the one or more date reminder notifications to the notification recipient;
(C) enabling the notification recipient to purchase the at least one item that would be suitable as the gift for the gift recipient for the at least one special event, wherein the at least one item is determined to be suitable as the gift for the gift recipient for the at least one special event by a remote computing system based at least in part on social network data associated with the gift recipient.

23. A computer system for recommending gifts for special events, the system comprising:
at least one processor, wherein the computer system is configured for:
(A) receiving event data associated with a gift recipient, wherein the event data comprises a date of at least one special event;
(B) receiving wish-list data associated with the gift recipient, wherein the wish-list data comprises data associated with at least one item indicated by the gift recipient to be included in a wish-list;
(C) receiving social network data indicating that the gift recipient and a notification recipient are connected on a social network;
(D) determining that the date of the at least one special event occurs in the near future;
(E) at least partially in response to determining that the date of the at least one special event occurs in the near future, conveying a date reminder notification to the notification recipient, wherein the notification comprises the date of the at least one special event; and
(F) enabling the notification recipient to contribute payment to the at least one item included in the wish-list associated with the gift recipient.

24. The computer system of claim 23, wherein:
(A) the at least one item can be purchased for a total price; and
(B) enabling the notification recipient to contribute payment to the at least one item included in the wish-list associated with the gift recipient comprises enabling the notification recipient to contribute a partial payment toward the total price of the at least one item.

25. The computer system of claim 23, wherein:
(A) the at least one item can be purchased for a total price; and
(B) enabling the notification recipient to contribute payment to the at least one item included in the wish-list associated with the gift recipient comprises enabling the notification recipient to contribute a payment comprising the total price of the at least one item.
